(19) United States
(12) Patent Application Publication
(10) Pub. No.: US 2009/0277877 A1
(43) Pub. Date: Nov. 12, 2009

(54) APPARATUS AND METHOD FOR WELDING OBJECTS

(76) Inventors: Craig A. Daniels, Bay Village, OH (US); Joseph Langan, Mentor, OH (US)

Correspondence Address: BLISS MCGLYNN, P.C., 2075 WEST BIG BEAVER ROAD, SUITE 600, TROY, MI, 48084, US

(21) Appl. No.: 12/117,009

(22) Filed: May 8, 2008

(51) Int. Cl. B23K 9/00; B23K 9/16

(52) U.S. Cl. 219/74; 219/75

(57) ABSTRACT

An apparatus and method for welding objects having a butt joint includes providing at least one welding torch, providing a fixture to hold at least one object to be welded, moving the at least one welding torch over the butt joint, heating the butt joint with the at least one welding torch, forming a bridge across a gap of the butt joint from heated parent material of the at least one object in a first welding operation, moving the at least one welding torch over the butt joint, and filling the gap of the butt joint with a filler material being fused with the bridge of the butt joint in a second welding operation to weld the butt joint together.

### BACKGROUND OF THE INVENTION

1. Field of the Invention

The present invention relates generally to welding and, more specifically, to an apparatus and method for welding objects having a butt joint.

2. Description of the Related Art

It is known to weld objects with automated machinery. One such apparatus is disclosed in U.S. Pat. No. 6,256,701 to Bickel et al. In this patent, the apparatus includes an induction coil mounted with a welding torch such that the induction coil passes over a weld path on the object prior to the welding torch. The apparatus may also include a robot (or robotic arm or arms), to which the torch and coil are mounted, such that the robotic arm (or arms) move the torch and coil along the weld path.

One disadvantage of the above-described apparatus is that an induction coil is used to heat the weld path on the object. Another disadvantage of this apparatus is that it is difficult to use the apparatus to weld a butt joint. A further disadvantage of this apparatus is the time involved to weld the object.

Therefore, it is desirable to provide an apparatus and method for welding an object that eliminates an induction coil and insures full penetration and full fusion of the weld into the parent material of the object. It is also desirable to provide an apparatus and method for welding an object having a butt joint that ensures a better weld joint for quality control. It is further desirable to provide an apparatus and method for welding an object that results in relatively fast cycle times. Thus, there is a need in the art to provide an apparatus and method that meets at least one of these desires.

### SUMMARY OF THE INVENTION

It is, therefore, one object of the present invention to provide a new apparatus and method for welding objects.

It is another object of the present invention to provide an apparatus and method for welding objects that have a butt joint.

It is yet another object of the present invention to provide an apparatus and method for welding objects that provides full penetration of the weld.

It is still another object of the present invention to provide an apparatus and method for welding objects that allows faster weld cycle times.

To achieve one or more of the foregoing objects, the present invention is an apparatus for welding objects having a butt joint. The apparatus includes a robot having at least one welding torch. The apparatus also includes a fixture for holding at least one object to be welded. The apparatus further includes a controller communicating with the robot to operate the robot to move the at least one welding torch over the butt joint to heat the butt joint and form a bridge across the gap of the butt joint from heated parent material of the at least one object in a first welding operation and to move the at least one welding torch over the butt joint to fill the gap of butt joint with a filler material being fused with the bridge of the butt joint in a second welding operation to weld the butt joint together.

Also, the present invention is a method for welding objects having a butt joint. The method includes the steps of providing at least one welding torch. The method also includes the steps of providing a fixture to hold at least one object to be welded and moving the at least one welding torch over the butt joint. The method includes the steps of heating the butt joint with the at least one welding torch and forming a bridge across a gap of the butt joint from heated parent material of the at least one object in a first welding operation. The method further includes the steps of moving the at least one welding torch over the butt joint and filling the gap of the butt joint with a filler material being fused with the bridge of the butt joint in a second welding operation to weld the butt joint together.

One advantage of the present invention is that a new apparatus and method is provided for welding objects having a butt joint at a high rate of speed. Another advantage of the present invention is that the apparatus and method for welding objects allows extremely rapid weld cycles with no loss of material. Yet another advantage of the present invention is that the apparatus and method for welding objects improves the quality of the weld with full penetration and 100% weld fusion. Still another object of the present invention is that the apparatus and method can be used on butt joints for square groove welding applications with no bevel or end preparation of the material to be welded. A further advantage of the present invention is that the apparatus and method provides excellent weld quality, high deposition rates, and increased productivity. Yet a further advantage of the present invention is that the apparatus and method is fully automated, but may be semi-automatic or manual.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a front elevational view of an apparatus, according to the present invention, for welding objects illustrating a first operational state.

FIG. 2 is a view similar to FIG. 1 of the apparatus for welding objects illustrating a second operational state.

FIG. 3 is a front elevational view of a portion of the apparatus of FIG. 1 illustrating the object prior to being welded.

FIG. 4 is a view similar to FIG. 3 illustrating the object after the first operational state of welding.

FIG. 5 is a view similar to FIG. 3 illustrating the object after the second operational state of welding.

FIG. 6 is a view similar to FIG. 3 illustrating the object completely welded and finished.

FIG. 7 is a front elevational view of a welded portion of the object welded by the apparatus of FIG. 1.

FIG. 8 is a view similar to FIG. 7 illustrating another embodiment of the welded portion of the object.

FIG. 9 is a view similar to FIG. 7 illustrating yet another embodiment of the welded portion of the object.

FIG. 10 is a view similar to FIG. 7 illustrating still another embodiment of the welded portion of the object.

FIG. 11 is a view similar to FIG. 7 illustrating a further embodiment of the welded portion of the object.

FIG. 12 is a view similar to FIG. 7 illustrating a still further embodiment of the welded portion of the object.

### DESCRIPTION OF THE PREFERRED EMBODIMENT(S)

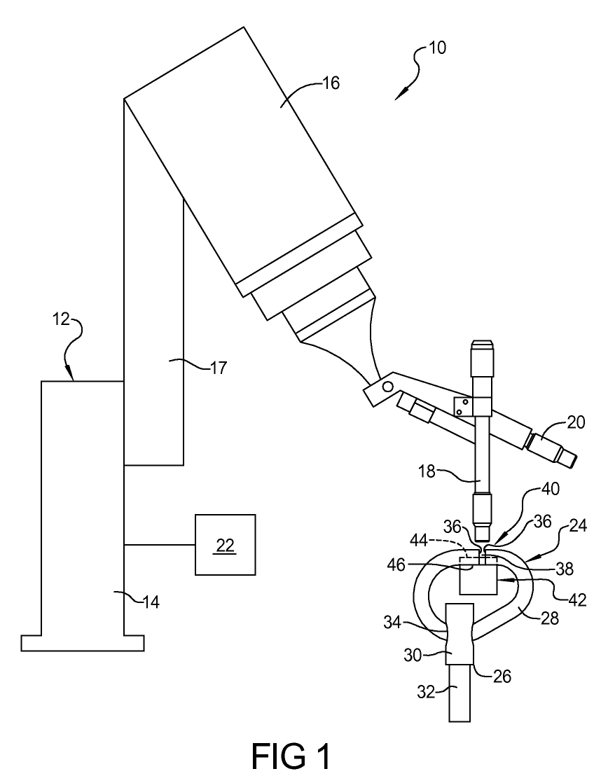

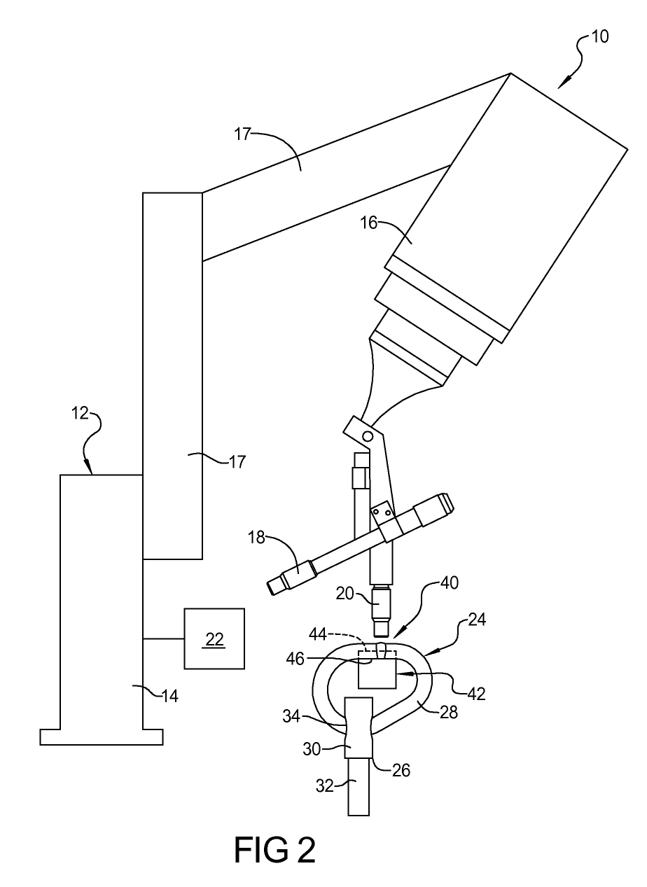

Referring now to the drawings, and in particular FIGS. 1 and 2, one embodiment of an apparatus 10, according to the present invention, is shown. The apparatus 10 includes a robot, generally indicated at 12. The robot 12 includes a base 14 and at least one movable arm 16 movably attached to the base 14 via one or more intermediate movable members 17. The apparatus 10 also includes at least one welding torch or a plurality of welding torches mounted to the movable arm 16. In the embodiment illustrated, the apparatus 10 includes a first welding torch 18 mounted to the movable arm 16 and a second welding torch 20 mounted to the movable arm 16. The first welding torch 18 is of a gas tungsten arc welding (GTAW), also known as tungsten inert gas (TIG) welding, type in which an arc welding process uses a nonconsumable tungsten electrode. The second welding torch 20 is of a gas metal arc welding (GMAW), also known as metal inert gas (MIG), type in which a continuous and consumable wire electrode and a shielding gas are fed through the welding torch. The apparatus 10 includes a controller 22 communicating with the robot 12 to move the welding torches 18 and 20 and to operate the welding torches 18 and 20. The controller 22 includes a microprocessor, memory, and input/output. The controller 22 is programmed to direct or control the movement of the movable arm 16 and welding torches 18 and 20. It should be appreciated that, except for mounting the welding torches 18 and 20 to the movable arm 16 of the robot 12, the welding torches 18 and 20 are conventional and known in the art. It should also be appreciated that the robot 12 is conventional and known in the art. It should further be appreciated that GTAW and GMAW are conventional and known in the art.

Referring to FIGS. 1 through 7, in one embodiment, the object(s) to be welded has a butt joint. In the embodiment illustrated, the object to be welded is a ring and bolt assembly, generally indicated at 24. The ring and bolt assembly 24 includes a bolt 26 and a ring 28 extending through the bolt 26. The bolt 26 has a head 30 and a shaft 32 extending axially from the head 30. The head 30 also has an aperture 34 extending therethrough. The bolt 26 is made of a metal material.

In one embodiment, the ring 28 has a generally circular cross sectional shape. The ring 28 is formed from straight bar stock that is extended through the aperture 34 in the head 30 of the bolt 26. The bar stock of the ring 28 is then bent into a generally circular shape with ends 36 spaced from each other to form a gap 38 therebetween as a butt joint, generally indicated at 40. As illustrated in FIG. 3, the butt joint 40 has the gap 38 between the ends 36 of the ring 28 with no bevel or end preparation of the material to be welded. As illustrated, the butt joint 40 has a typical weld gap that may range in size from 0.125 inches to one (1) inch. It should be appreciated that, as the bar stock increases in diameter, the gap size increases. It should also be appreciated that the ends 36 of the ring 28 are generally square or flat and there is no end preparation as illustrated in FIG. 3. It should further be appreciated that any shape or combination of shapes can be effectively joined using the welding process, e.g.: rectangular flat stock to square or round; round to round; or ½″ round to ¾″ round.

The ring 28 is made of a metal material. The metal material may be a solid ferrous or non-ferrous material. It should be appreciated that the welding process will effectively create a full penetration, full fusion, weld joint between the same (ring, link, two pieces of material) or dissimilar (stainless to carbon steel, inconel to steel) solid ferrous or non ferrous material. It should also be appreciated that the welding process effectively welds butt jointed materials regardless of material end preparation. It should further be appreciated that a more inclusive summary of weld butt joints is disclosed in AWS D1.1 American National Standard and FIGS. 3.3 & 3.4 of the American Welding Society (AWS).

Referring to FIGS. 1 through 5, the apparatus 10 also includes a fixture, generally indicated at 42, for holding object(s) to be welded. In the embodiment illustrated, the object to be welded is the ring and bolt assembly 24. The fixture 42 is generally rectangular in shape although other suitable shapes may be used. The fixture 42 has an upper surface 44 with a recess 46 extending therein to receive the butt joint 40 of the ring 28. The recess 46 provides for containment of molten welding wire/parent metal material. The fixture 42 is of a chemical, physical, and mechanical composition that prevents bonding of the fixture 42 with molten material. The fixture 42 may be made of a metallic or non-metallic material. It should be appreciated that the molten material does not bond to the material of the fixture 42. It should also be appreciated that the fixture 42 is made based on material(s) to be welded and is of a size and shape appropriate for the weld butt joint. It should further be appreciated that the fixture 42 is kept at a temperature lower than the molten material due to its physical, chemical, and mechanical properties.

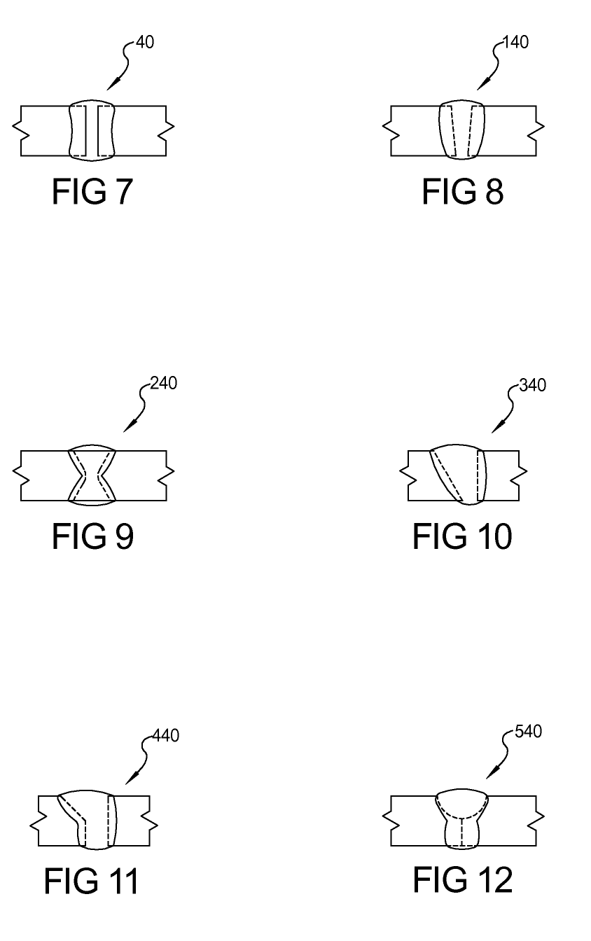

Referring to FIGS. 7 through 12, various types of weld joints may be welded. For each figure, the reference numerals for the butt joint 40 are increased by one hundred (100) for each figure. As illustrated in FIG. 7, the weld joint is a square groove weld butt joint 40. As illustrated in FIG. 8, the weld joint is a single “V” groove weld butt joint 140. As illustrated in FIG. 9, the weld joint is a double “V” groove weld butt joint 240. As illustrated in FIG. 10, the weld joint is a single bevel groove weld butt joint 340. As illustrated in FIG. 11, the weld joint is a single bevel groove weld butt joint 440. As illustrated in FIG. 12, the weld joint is a single “U” groove weld butt joint 540. It should be appreciated that FIGS. 7 through 12 are not all inclusive of weld butt joints and only illustrate some of the possible weld butt joints for the present invention. It should also be appreciated that the weld butt joints are conventional and known in the art.

In operation of the apparatus 10, an operator (not shown) sets the object(s) to be welded in the fixture 42. In the embodiment illustrated, the operator sets the butt joint 40 of the ring 28 in the recess 46 of the fixture 42 such that the ring 28 rests within the fixture 42 as illustrated in FIG. 3. In one embodiment, the controller 22 sets a GMAW wire back on the second welding torch 20 and the robot 12 moves the movable arm 16 to touch sense the gap 48 in the ring 28 with the GMAW wire for the second welding torch 20. It should be appreciated that the steps of setting the wire back and touch sensing the gap are optional.

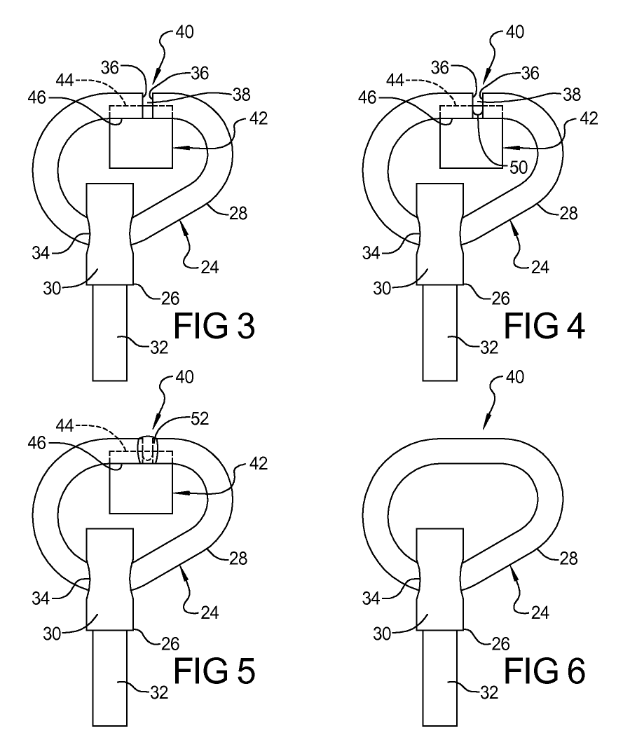

The robot 12 moves the first welding torch 18 over the butt joint 40 to heat up the area adjacent the gap 38 on the ring 28. In one embodiment, the first welding torch 18 comes into a weld position for pre-purge set at an angle to an inside wall of the ends 36 of the ring 28. During the welding process, the first welding torch 18 begins on one side with single or multiple passes per side at a distance from the inside wall of the end 36 starting at a distance from top and progressing down per pass. The same process is repeated on the opposite or second side. At completion of the inside wall of the ends 36, the molten material from the ends 36 flow a distance down and in each direction on bottom of the recess 46 of the fixture 42, creating full fusion. The first welding torch 18 stops with a post-purge. At this point, the original parent material of the inside walls of the ends 36 has been eroded into a molten material which flows downwardly and fuses together to form a bridge 50 across the gap 38 of the butt joint 40 as illustrated in FIG. 4. It should be appreciated that the molten material fills up from the bottom of the recess 46 on the fixture 42 and does not bond to the fixture 42. It should also be appreciated that the back and forth travel of the welding torch 18 insures 100% fusion. It should further be appreciated that, in this embodiment, the bridge 50 is created by the initial TIG process prior to any MIG welding. It should still further be appreciated that the first welding torch 18 does not use wire or filler material, but pre-heats the butt joint 40 to a sufficient temperature to create initial fusion of the molten material to form the bridge 50.

In the embodiment illustrated, the robot 12 then uses the second welding torch 20 to fill the gap 38 of the butt joint 40 with weld material. The second welding torch 20 begins on one side or end 36 and moves to the opposite side or end 36. The second welding torch 20 moves from side to side in an oscillating motion. Upon completion of that motion, the second welding torch 18 stops with a post-purge to complete a weld 52 as illustrated in FIG. 5. It should be appreciated that, once the MIG process begins, the ends 36 are already molten, thereby allowing the filler wire introduced in the MIG process to fully penetrate and fuse with the parent material. It should also be appreciated that the filler material fills the gap 38 and fuses to the bridge 50 to form the weld 52. It should further be appreciated that, once proper initial fusion is achieved, the remaining joint is fully fused and fully penetrated through the continued deliberate application of heat and filler wire over a controlled period of time.

After welding, the welded object(s) such as the ring 28 is removed from the fixture 42. If a flush finish is desired, excess weld can be removed from the ring 28 without affecting the weld integrity. The weld 52 of the butt joint 40 is finish ground, for example by sanding, to be flush with the remaining surface of the ring 28 as illustrated in FIG. 6. It should be appreciated that the above welding process must be done in a completely inert atmosphere. It should also be appreciated that the location and orientation of the welding torches 18 and 20, the rate of the travel, rate of filler wire addition, along with other welding variables must be controlled.

Accordingly, the present invention is a method of welding objects having a butt joint in which, in the embodiment illustrated, two welding processes, TIG and MIG, are utilized. This embodiment of the present invention uses a TIG process to simultaneously pre-heat material and initiate 100% fusion/100% penetration at the bottom of the butt joint. This embodiment of the present invention also uses a MIG process in final passes to weld the butt joint after the initial root passes have been completed using the TIG process. The method of the present invention achieves a full penetration, full fusion welded butt joint, of any design. With the present invention, same or dissimilar ferrous and or non ferrous materials of any solid shape can effectively be joined using this welding process. The apparatus 10 of the present invention utilizes a containment fixture 42 and heat and filler wire are applied to the weld butt joint via the method of the present invention, which may be performed manually, semi-automatically, or automatically/robotically. The resulting welded butt joint meets or exceeds the most strict classification of all the following standards: AWS D1.1, AWS D17.1, TACOM 12479550, MIL-STD-2219, MIL-STD-1261 (at a minimum) and is as strong or stronger than the parent metal material(s).

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. An apparatus for welding objects having a butt joint comprising:
a robot having at least one welding torch;
a fixture for holding at least one object to be welded; and
a controller communicating with said robot to operate said robot to move said at least one welding torch over the butt joint to heat the butt joint and form a bridge across a gap of the butt joint from heated parent material of the at least one object in a first welding operation and to move said at least one welding torch over the butt joint to fill the gap of butt joint with a filler material being fused with the bridge of the butt joint in a second welding operation to weld the butt joint together.

2. An apparatus as set forth in claim 1 wherein said at least one welding torch comprises a first welding torch and a second welding torch.

3. An apparatus as set forth in claim 2 wherein said first welding torch is a tungsten inert gas (TIG) welding torch.

4. An apparatus as set forth in claim 2 wherein said second welding torch is a metal inert gas (MIG) welding torch.

5. An apparatus as set forth in claim 4 including a gas metal arc welding wire used by said MIG welding torch to fill the gap with filler material.

6. An apparatus as set forth in claim 2 wherein said robot has at least one movable arm, said first welding torch and said second welding torch being mounted to said at least one movable arm.

7. An apparatus as set forth in claim 1 wherein said fixture includes a recess for receiving the butt joint of the at least one object to be welded.

8. An apparatus as set forth in claim 1 wherein said fixture contains a molten material from the at least one object and prevents the molten material from bonding thereto.

9. An apparatus for welding objects having a butt joint comprising:
a robot having a plurality of welding torches, said welding torches comprising a tungsten inert gas (TIG) welding torch and a metal inert gas (MIG) welding torch;
a fixture for holding at least one object to be welded; and
a controller communicating with said robot to operate said robot to move said TIG welding torch over the butt joint to heat the butt joint and form a bridge across a gap of the butt joint from heated parent material of the object and to move said MIG welding torch over the butt joint to fill the gap of butt joint with a gas metal arc welding material being fused with the bridge of the butt joint to weld the butt joint together.

10. A method for welding objects having a butt joint, said method comprising the steps of:
providing at least one welding torch;
providing a fixture to hold at least one object to be welded;
moving the welding torch over the butt joint;
heating the butt joint with the at least one welding torch and forming a bridge across a gap of the butt joint from heated parent material of the object in a first welding operation; and
moving the at least one welding torch over the butt joint and filling the gap of the butt joint with a filler material being fused with the bridge of the butt joint in a second welding operation to weld the butt joint together.

11. A method as set forth in claim 10 including the step of setting the at least one object to be welded in the fixture prior to said step of moving the at least one welding torch.

12. A method as set forth in claim 11 wherein said step of setting comprises setting the butt joint of the at least one object in a recess of the fixture.

13. A method as set forth in claim 10 wherein said step of providing comprises providing a first welding torch and a second welding torch.

14. A method as set forth in claim 13 wherein said step of providing a first welding torch and a second welding torch comprises providing a first welding torch as a tungsten inert gas (TIG) welding torch and a second welding torch as a metal inert gas (MIG) welding torch.

15. A method as set forth in claim 13 including the step of providing a robot with a movable arm, the first welding torch and the second welding torch being mounted to the at least one movable arm.

16. A method as set forth in claim 15 including a controller communicating with the robot to operate the robot to move the first welding torch and the second welding torch.

17. A method as set forth in claim 10 including the step of using a gas metal arc welding (GMAW) wire by the second welding torch to fill the gap of the butt joint with filler material.

18. A method as set forth in claim 10 including the step of finishing a welded area of the butt joint to be flush with a surface of the at least one object.

19. A method as set forth in claim 10 wherein said step of providing a fixture comprises providing a fixture to contain a molten material from the at least one object and prevent the molten material from bonding thereto.

20. A method for welding objects having a butt joint, said method comprising the steps of:
providing a tungsten inert gas (TIG) welding torch and a metal inert gas (MIG) welding torch;
providing a fixture to hold at least one object to be welded;
moving the TIG welding torch over the butt joint;
heating the butt joint with the TIG welding torch and forming a bridge at a bottom of the butt joint across a gap of the butt joint from heated parent material of the at least one object; and
moving the MIG welding torch over the butt joint and filling the gap of the butt joint with a gas metal arc welding material being fused with the bridge of the butt joint and welding the butt joint together.
